(19) United States
(12) Patent Application Publication
(10) Pub. No.: US 2019/0351742 A1
(43) Pub. Date: Nov. 21, 2019

(54) AIR CONDITIONER FOR VEHICLE

(71) Applicant: DENSO CORPORATION, Kariya-city (JP)

(72) Inventor: Toshiharu FUJII, Kariya-city (JP)

(21) Appl. No.: 16/524,720

(22) Filed: Jul. 29, 2019

Related U.S. Application Data
(63) Continuation of application No. PCT/JP2017/046325, filed on Dec. 25, 2017.

(30) Foreign Application Priority Data
Feb. 16, 2017 (JP) 2017-026982

(51) Int. Cl. B60H 1/32; B60N 2/56

(52) U.S. Cl. CPC B60H 1/32; B60N 2/5657; B60N 2/5628

(57) ABSTRACT

The air conditioner includes: a cabin air conditioner, a seat air conditioner, and a controller that controls the cabin air conditioner and the seat air conditioner. The cabin air conditioner includes an indoor air blower that blows air into the cabin, a cooler that cools air blown by the indoor air blower, and a thermal storage unit that stores cold heat generated by the cooler. The seat air conditioner includes a ventilation opening formed on a seat in the cabin, and a seat air blower that draws air inside the cabin through the ventilation opening. The controller controls the cabin air conditioner to cool the air by the cold heat stored in the thermal storage unit, and lowers an air conditioning performance of the cabin air conditioner when the seat air conditioner is operated.

### CROSS REFERENCE TO RELATED APPLICATION

The present application is a continuation application of International Patent Application No. PCT/JP2017/046325 filed on Dec. 25, 2017, which designated the U.S. and claims the benefit of priority from Japanese Patent Application No. 2017-26982 filed on Feb. 16, 2017. The entire disclosures of all of the above applications are incorporated herein by reference.

### TECHNICAL FIELD

The present disclosure relates to an air conditioner for a vehicle.

### BACKGROUND ART

There have been conventionally developed various techniques relating to air-conditioning in order to improve the comfort of an occupant inside a cabin of a vehicle.

### SUMMARY

According to an aspect of the present disclosure, an air conditioner for a vehicle includes:

a cabin air conditioner disposed on a front side of a cabin of a vehicle, the cabin air conditioner including an indoor air blower that blows air into the cabin, a cooler that cools air blown by the indoor air blower, and a thermal storage unit that stores cold heat generated by the cooler;

a seat air conditioner including a ventilation opening formed on a seat disposed in the cabin and a seat air blower that draws air inside the cabin through the ventilation opening; and

a controller that controls operations of the cabin air conditioner and the seat air conditioner.

The controller controls the cabin air conditioner to cool the air by the cold heat stored in the thermal storage unit, and lowers an air conditioning performance of the cabin air conditioner when the seat air conditioner is operated.

### BRIEF DESCRIPTION OF DRAWINGS

FIG. 1 is a side view illustrating a schematic configuration of a vehicle air conditioner according to a present embodiment.

FIG. 2 is a diagram of the vehicle air conditioner according to the present embodiment.

FIG. 3 is a front view illustrating a schematic configuration of an evaporator in a cabin air conditioner.

FIG. 4 is a side view illustrating a flow of cold air during a cold-storing cooling operation according to the present embodiment.

FIG. 5 is a flowchart explaining a control process during the cold-storing cooling operation according to the present embodiment.

FIG. 6 is a graph relating to a cooling efficiency of the cold-storing cooling operation in the vehicle air conditioner according to the present embodiment.

### DESCRIPTION OF EMBODIMENTS

To begin with, examples of relevant techniques will be described.

A vehicle air conditioner includes a cabin air conditioner which performs air conditioning for a cabin, a seat air conditioner which performs air conditioning for a seat, and an air conditioning controller. In the vehicle air conditioner, the conditions inside the cabin, such as temperature and solar radiation amount, are detected, and the operations of the cabin air conditioner and the seat air conditioner are controlled according to the results of the detection.

A cold storage heat exchanger is used in a refrigeration cycle apparatus. The cold storage heat exchanger includes a cold-storing material container disposed between refrigerant pipes, to enable cold storage and cold release to a cold-storing material in the cold-storing material container. A cooling operation can be achieved using the cold stored in the cold-storing material by using the cold storage heat exchanger.

It can be considered that the cold storage heat exchanger can be used in the cabin air conditioner of the vehicle air conditioner. According to such a configuration, it is possible to perform cooling using cold stored in the cold-storing material in the cold storage heat exchanger as one mode of cooling in the cabin air conditioner.

The capacity of the cold-storing material as a thermal storage unit is determined according to, for example, material components of the cold-storing material. Thus, cold that can be stored in the cold storage heat exchanger is limited. In order to perform cooling using cold stored in the thermal storage unit in the configuration as described above, it is necessary to efficiently use cold stored in the thermal storage unit. Further, how to efficiently improve the comfort of an occupant using the limited cold is an issue in a cooling operation using the cold stored in the thermal storage unit.

The present disclosure relates to a vehicle air conditioner including a cabin air conditioner with a thermal storage unit, and a seat air conditioner. The present disclosure provides a vehicle air conditioner capable of improving the efficiency of cooling using cold heat stored in a thermal storage unit.

According to an aspect of the present disclosure, an air conditioner for a vehicle includes:

a cabin air conditioner disposed on a front side of a cabin of a vehicle, the cabin air conditioner including an indoor air blower that blows air into the cabin, a cooler that cools air blown by the indoor air blower, and a thermal storage unit that stores cold heat generated by the cooler;

a seat air conditioner including a ventilation opening formed on a seat disposed in the cabin and a seat air blower that draws air inside the cabin through the ventilation opening; and

a controller that controls operations of the cabin air conditioner and the seat air conditioner.

The controller controls the cabin air conditioner to cool the air by the cold heat stored in the thermal storage unit, and lowers an air conditioning performance of the cabin air conditioner when the seat air conditioner is operated.

According to the air conditioner, the cabin air conditioner is capable of executing one mode that cools air blown by the air blower using the cooler and blows the cooled air into the cabin, and another mode that cools air blown by the air blower using the cold heat stored in the thermal storage unit and blows the cooled air into the cabin. Thus, it is possible to improve the comfort inside the cabin.

The seat air conditioner is capable of drawing air inside the cabin through the ventilation opening of the seat by the operation of the seat air blower. Thus, it is possible to form a flow of air flowing toward the seat inside the cabin to improve the comfort inside the cabin.

According to the air conditioner, it is possible to direct the flow of air cooled by cold in the thermal storage unit toward the ventilation opening of the seat by operating the seat air conditioner simultaneously with cooling the air by cold stored in the thermal storage unit. Thus, it is possible to efficiently improve the comfort of the occupant inside the cabin.

At this time, the air conditioner lowers the air conditioning performance of the cabin air conditioner. Thus, it is possible to improve the comfort of the occupant inside the cabin and the efficiency of the energy consumption as the air conditioner as compared to a case where the cabin air conditioner and the seat air conditioner are simply operated at the same time. According to the air conditioner, it is possible to use cold stored in the thermal storage unit for a longer period of time and contribute to energy saving as the air conditioner.

Hereinafter, an embodiment will be described according to the drawings. Same or equivalent portions among respective embodiments below are labeled with same reference numerals in the drawings.

A vehicle air conditioner 1 according to the present embodiment is mounted on a vehicle that is driven by a vehicle engine E and used for adjusting the temperature inside a cabin C of the vehicle to an appropriate temperature.

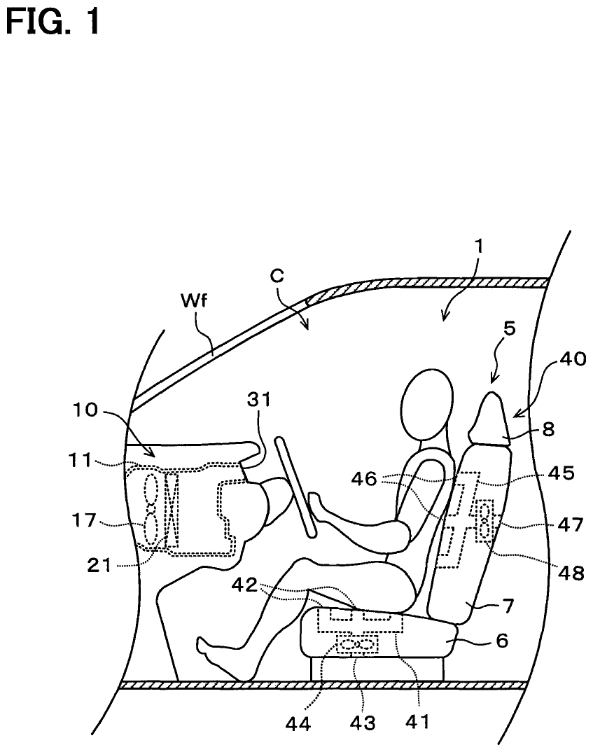

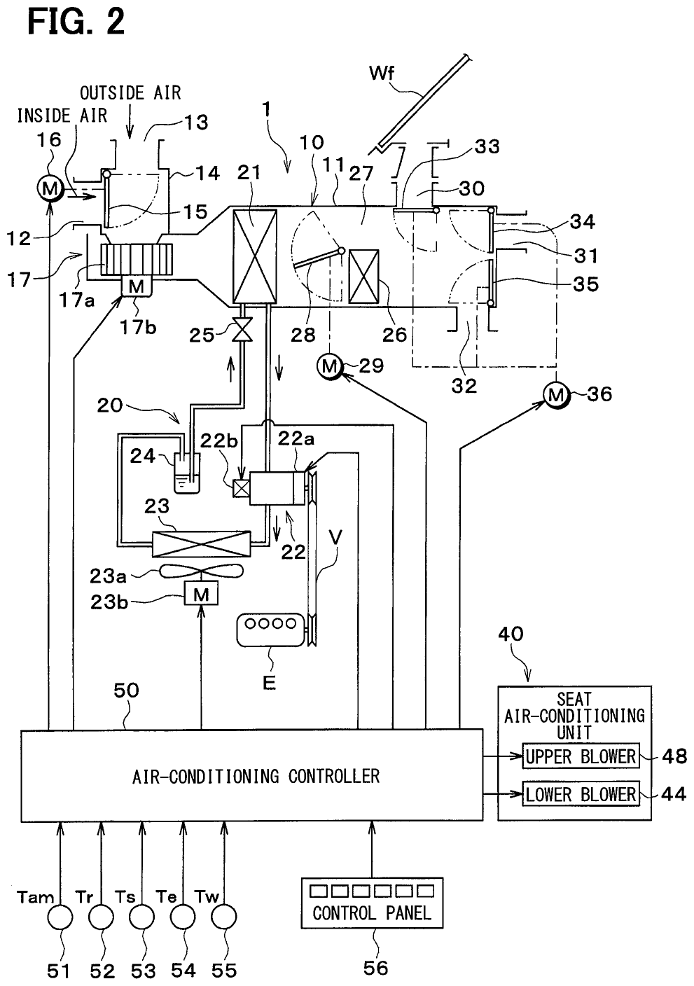

As illustrated in FIGS. 1 and 2, the vehicle air conditioner 1 includes a cabin air conditioning unit 10 which is disposed on the front side of the cabin C, a seat air conditioning unit 40 which is disposed in a seat 5 on which an occupant is seated inside the cabin C, and an air conditioning controller 50 which controls the operations of the cabin air conditioning unit 10 and the seat air conditioning unit 40.

First, the configuration of the cabin air conditioning unit 10 in the vehicle air conditioner 1 will be described in detail with reference to the drawings. As illustrated in FIGS. 1 and 2, the cabin air conditioning unit 10 is disposed inside a meter (such as an instrument panel) on the foremost part of the cabin C and capable of supplying conditioned air adjusted by a refrigeration cycle 20 into the cabin C. The cabin air conditioning unit 10 is an example of the cabin air conditioner.

The cabin air conditioning unit 10 includes a casing 11 which forms an outer shell thereof, and an inside and outside air switching box 14, an indoor air blower 17, a heater core 26, a bypass passage 27, and an air mix door 28 which are housed in the casing 11. The cabin air conditioning unit 10 further includes the refrigeration cycle 20 which functions as the cooler.

The casing 11 forms an air passage for ventilation air blown into the cabin C. The casing 11 is molded of resin having a certain degree of elasticity and high strength (e.g., polypropylene).

As illustrated in FIG. 2, the inside and outside air switching box 14 is disposed on the most upstream part of the air passage of the casing 11. The inside and outside air switching box 14 includes an inside air introduction port 12 which communicates with the inside of the cabin C, an outside air introduction port 13 which communicates with the outside of the cabin C, an inside and outside air switching door 15, and a servomotor 16.

The inside and outside air switching door 15 is rotatably disposed inside the inside and outside air switching box 14 and driven by the servomotor 16. The inside and outside air switching box 14 is capable of switching among an inside air mode for introducing inside air (air inside the cabin) through the inside air introduction port 12, an outside air mode for introducing outside air (air outside the cabin) through the outside air introduction port 13, and a half inside air mode for introducing inside air and outside air at the same time by controlling driving of the inside and outside air switching door 15.

The indoor air blower 17 is an electric blower disposed on the downstream side of the inside and outside air switching box 14. The indoor air blower 17 is configured to blow air into the cabin C by driving a centrifugal multi-blade fan 17a by a motor 17b. The indoor air blower 17 is capable of adjusting an air blowing amount into the cabin C by controlling the motor 17b by the air conditioning controller 50. Thus, the indoor air blower 17 functions as the air blower.

As illustrated in FIGS. 1 and 2, an evaporator 21 which is included in the refrigeration cycle 20 is disposed on the downstream side of the indoor air blower 17. The refrigeration cycle 20 in the cabin air conditioning unit 10 is configured as a vapor compression refrigeration cycle. The refrigeration cycle 20 includes, in addition to the evaporator 21, a compressor 22, a condenser 23, a gas-liquid separator 24, and an expansion valve 25. The refrigeration cycle 20 is a part of the cooler.

The refrigeration cycle 20 employs an HFC refrigerant (specifically, R134a) as a refrigerant and constitutes a vapor compression subcritical refrigeration cycle in which the high-pressure side refrigerant pressure does not exceed the critical pressure of the refrigerant. An HFO refrigerant (e.g., R1234yf) or a natural refrigerant (e.g., R744) may be employed as the refrigerant. A refrigerating machine oil for lubricating the compressor 22 is mixed in the refrigerant. Part of the refrigerating machine oil circulates through the cycle together with the refrigerant.

In the refrigeration cycle 20, the low-pressure refrigerant flowing into the evaporator 21 absorbs heat from ventilation air blown by the indoor air blower 17 and evaporates. Thus, the evaporator 21 is capable of cooling the ventilation air blown from the indoor air blower 17. The evaporator 21 has a cold storage function for storing cold heat generated by evaporation of the refrigerant. A specific configuration of the evaporator 21 will be described below with reference to the drawings.

The compressor 22 in the refrigeration cycle 20 sucks, compresses, and discharges the refrigerant of the refrigeration cycle 20. The compressor 22 is driven by a rotary power of the vehicle engine E, the rotary power being transmitted through an electromagnetic clutch 22a, a pulley, and a belt V. Thus, the compressor 22 according to the present embodiment is configured to stop operating along with a stop of the vehicle engine E. The vehicle engine E is an example of the engine.

The compressor 22 is a variable displacement compressor whose discharge capacity can be continuously and variably controlled by a control signal from the outside. Specifically, the compressor 22 includes an electromagnetic displacement control valve 22b whose opening degree is varied by a control current output from the air conditioning controller 50.

The compressor 22 adjusts the opening degree of the electromagnetic displacement control valve 22b to control a control pressure in the compressor 22 to change a stroke of a piston. Accordingly, the compressor 22 is capable of changing the discharge capacity continuously within the range of approximately 0% to 100%.

The condenser 23 exchanges heat between the refrigerant discharged from the compressor 22 and air outside the cabin (that is, outside air) blown from a cooling fan 23a as an outdoor air blower to condense the refrigerant. The condenser 23 functions as a so-called radiator.

The cooling fan 23a is an electric air blower. An operating rate (that is, a rotation speed) of the cooling fan 23a is controlled by a control voltage input to a motor 23b from the air conditioning controller 50. That is, the amount of air blown by the cooling fan 23a can be appropriately controlled by the air conditioning controller 50.

The gas-liquid separator 24 is a receiver that separates the refrigerant condensed by the condenser 23 into gas and liquid and stores a surplus refrigerant, and passes only a liquid-phase refrigerant to the downstream side.

The expansion valve 25 is a decompressor that decompresses and expands the liquid-phase refrigerant separated by the gas-liquid separator 24. The expansion valve 25 is provided with a valve element and an electric actuator, and includes an electric variable throttle mechanism. The valve element is capable of changing an opening degree of the refrigerant passage (in other words, a throttle opening degree). The electric actuator includes a stepping motor that changes the throttle opening degree of the valve element.

The operation of the expansion valve 25 is controlled by a control signal output from the air conditioning controller 50. That is, the expansion valve 25 makes it possible to isenthalpically decompress the refrigerant in accordance with the control signal from the air conditioning controller 50 and control the throttle opening degree so that the degree of superheat of the refrigerant sucked into the compressor 22 becomes a predetermined value.

In the refrigeration cycle 20, the refrigerant decompressed and expanded by the expansion valve 25 flows into the evaporator 21 and evaporates, and then flows into the compressor 22 again. In this manner, the refrigeration cycle in which the refrigerant circulates to the compressor 22, the condenser 23, the gas-liquid separator 24, the expansion valve 25, the evaporator 21, and the compressor 22 in this order is constructed. The constituent devices (the evaporator 21, the compressor 22, the expansion valve 25 and the like) of the refrigeration cycle are connected through refrigerant pipes.

As illustrated in FIG. 2, the heater core 26 is disposed on the downstream side of air flow of the evaporator 21 in the cabin air conditioning unit 10. The heater core 26 heats air (cold air) that has passed through the evaporator 21 using a coolant of the vehicle engine E, the coolant circulating through an engine coolant circuit (not illustrated), as a heat source.

The bypass passage 27 is formed on the lateral side of the heater core 26. The bypass passage 27 detours air that has passed through the evaporator 21 around the heater core 26 and guides the air to the downstream side of air flow of the heater core 26.

The air mix door 28 is rotatably disposed on the downstream side of air flow relative to the evaporator 21 and on the upstream side of air flow relative to the heater core 26 and the bypass passage 27. The air mix door 28 is driven by a servomotor 29. In the cabin air conditioning unit 10, the rotation position (opening degree) of the air mix door 28 can be continuously adjusted by controlling the operation of the servomotor 29 by the air conditioning controller 50.

In the cabin air conditioning unit 10, the ratio between the amount of air (the amount of hot air) passing through the heater core 26 and the amount of air (the amount of cold air) passing through the bypass passage 27 to bypass the heater core 26 can be adjusted according to the opening degree of the air mix door 28. That is, the cabin air conditioning unit 10 is capable of adjusting the temperature of air blown into the cabin C.

Further, a defroster blowoff port 30, a face blowoff port 31, and a foot blowoff port 32 are disposed on the most downstream part of ventilation air flow of the casing 11. These blowoff ports are formed to blow conditioned air having a temperature adjusted by the air mix door 28 into the cabin C which is a space to be air-conditioned.

Specifically, the defroster blowoff port 30 is a blowoff port for blowing conditioned air toward a windshield Wf which is disposed on the front face of the vehicle. As illustrated in FIG. 1, the face blowoff port 31 is formed on a meter (such as an instrument panel) on the front part of the cabin C. The face blowoff port 31 is a blowoff port for blowing conditioned air to the upper body of an occupant seated on a seat 5. The foot blowoff port 32 is a blowoff port for blowing conditioned air to the feet of the occupant seated on the seat 5.

A defroster door 33, a face door 34, and a foot door 35 are rotatably disposed on the upstream side of the defroster blowoff port 30, the face blowoff port 31, and the foot blowoff port 32, respectively. That is, the defroster door 33 is capable of adjusting the open area of the defroster blowoff port 30. The face door 34 is capable of adjusting the open area of the face blowoff port 31. The foot door 35 is capable of adjusting the open area of the foot blowoff port 32.

The defroster door 33, the face door 34, and the foot door 35 are connected to a common servomotor 36 through a link mechanism. The operation of the servomotor 36 is controlled by a control signal output from the air conditioning controller 50. Thus, the cabin air conditioning unit 10 makes it possible to switch a blowoff port mode by controlling driving of the servomotor 36 by the air conditioning controller 50.

The cabin air conditioning unit 10 configured in this manner is capable of supplying conditioned air adjusted to an appropriate temperature into the cabin C by operating in accordance with control by the air conditioning controller 50. Accordingly, the cabin air conditioning unit 10 is capable of improving the comfort of the occupant inside the cabin C.

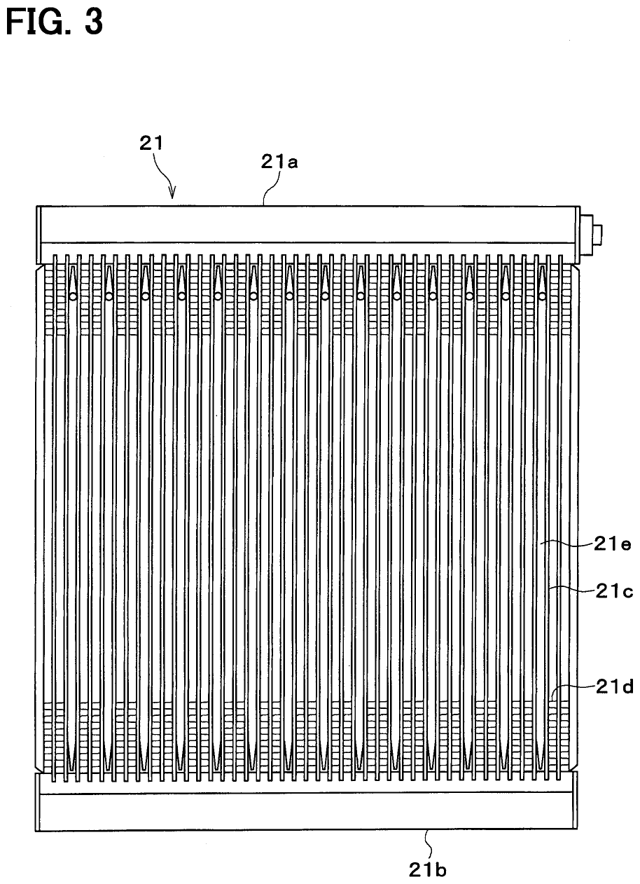

The specific configuration of the evaporator 21 in the refrigeration cycle 20 will be described in detail with reference to FIG. 3. As described above, the evaporator 21 is disposed on the downstream side of the indoor air blower 17 on the air passage inside the casing 11 of the cabin air conditioning unit 10, and crosses the entire air passage. Thus, the evaporator 21 is disposed in such a manner that the entire ventilation air blown from the indoor air blower 17 passes through the evaporator 21.

The evaporator 21 in the refrigeration cycle 20 is an indoor heat exchanger that performs an air cooling action for cooling ventilation air flowing through the air passage inside the casing 11 by heat exchange between the refrigerant flowing inside the evaporator 21 and the ventilation air and an air dehumidification action for dehumidifying air passing through the evaporator 21. The evaporator 21 has a cold storage function for storing cold by the air cooling action.

As illustrated in FIG. 3, the evaporator 21 includes an upper header tank 21a, a lower header tank 21b, and plural tubes 21c. The upper header tank 21a is disposed on the upper part of the evaporator 21. The lower header tank 21b is disposed parallel to the upper header tank 21a with a predetermined distance therebetween on the lower part of the evaporator 21.

The tubes 21c couple the upper header tank 21a and the lower header tank 21b to each other. The tubes 21c are arrayed at regular intervals. The upper end of each of the tubes 21c communicates with the inside of the upper header tank 21a. The lower end of each of the tubes 21c communicates with the inside of the lower header tank 21c.

The tube 21c is formed in a flat shape. The tube 21c is a multihole tube including plural refrigerant passages inside thereof. The tube 21c can be obtained, for example, by an extrusion method. The refrigerant passages extend in the longitudinal direction of the tube 21c and open on both ends of the tube 21c.

A clearance is formed between the tubes 21c. A fin 21d and a cold-storing material container 21e are disposed in the clearances. The fins 21d and the cold-storing material containers 21e are disposed, for example, with a predetermined regularity in the evaporator 21.

Each of the fins 21d is disposed in an air passage defined between two adjacent tubes 21c, and increases a contact area with ventilation air supplied to the cabin C. Each of the fins 21d is formed, for example, by bending a thin metal plate such as aluminum into a wavelike shape and joined to the two adjacent tubes 21c by brazing. Each of the fins 21d is thermally coupled to the two adjacent tubes 21c, and increases a heat exchange efficiency between the refrigerant flowing inside the tubes 21c and ventilation air passing through the evaporator 21.

Each of the cold-storing material containers 21e is disposed between two adjacent tubes 21c. A cold-storing material is stored inside the cold-storing material containers 21e. For example, paraffin whose freezing point is approximately 10° C. is used as the cold-storing material inside the cold-storing material containers 21e.

Each of the cold-storing material containers 21e is made of metal such as aluminum and joined to the two adjacent tubes 21c by brazing. That is, each of the cold-storing material containers 21e is thermally coupled to the two tubes 21c disposed on both sides thereof.

Accordingly, when the evaporator 21 evaporates the refrigerant inside each of the tubes 21c so that a heat absorbing action is exhibited, the evaporator 21 is capable of freezing the cold-storing material inside the cold-storing material containers 21e to store cold and functions as a cold storage heat exchanger.

The evaporator 21 configured in this manner stores cold in the cold-storing material inside each of the cold-storing material containers 21e during operation of the compressor 22 of the refrigeration cycle 20 in the cabin air conditioning unit 10 (that is, during a normal cooling operation by the refrigeration cycle 20). When the compressor 22 stops operating by a stop of the vehicle engine E, the evaporator 21 releases cold heat from the cold-storing material inside the cold-storing material containers 21e.

As a result, the cabin air conditioning unit 10 according to the present embodiment is capable of cooling ventilation air from the indoor air blower 17 by releasing cold heat stored in the cold-storing material even when the operation of the refrigeration cycle 20 is temporarily stopped.

The vehicle air conditioner 1 according to the present embodiment is configured in such a manner that the compressor 22 starts operating by a restart of the engine E when the blowout temperature of the evaporator 21 exceeds a predetermined reference blowout temperature KT (e.g., 15° C.). Thus, it is possible to extend a stop time of the compressor 22 by the cold storage function of the evaporator 21 and increase a power saving effect of the compressor 22. Along with the extension of the stop time of the compressor 22, it is possible to extend a stop time of the vehicle engine E and increase a fuel saving effect of the vehicle engine E.

Next, the configuration of the seat air conditioning unit 40 in the vehicle air conditioner 1 will be described in detail with reference to the drawings. As described above, the seat air conditioning unit 40 is disposed in the seat 5 on which the occupant is seated inside the cabin C and configured to operate in accordance with control by the air conditioning controller 50.

As illustrated in FIG. 1, the seat 5 includes a seating part 6, a backrest part 7, and a headrest part 8. The seat 5 is disposed slidably in the front-rear direction of the vehicle with respect to a floor surface of the cabin C. The seating part 6 is a part on which the occupant is seated, and includes a porous cushion part on the upper face thereof.

The backrest part 7 constitutes a part that supports the occupant seated on the seating part 6 from the back and includes a porous cushion part on the front face thereof. The headrest part 8 is disposed on the top of the backrest part 7 and capable of supporting the head of the occupant seated on the seat 5 from the back.

The seat air conditioning unit 40 is disposed inside the seating part 6 and the backrest part 7 in the seat 5. The seat air conditioning unit 40 includes a lower air passage 41, a lower blower 44, an upper air passage 45, and an upper blower 48.

The lower air passage 41 is disposed below the cushion part inside the seating part 6 of the seat 5. The lower air passage 41 is configured as a combination of metal pipes. Thus, the lower air passage 41 functions as a skeleton material part in the seating part 6 of the seat 5. The lower air passage 41 functions as a flow passage of air in the seating part 6 of the seat air conditioning unit 40 and includes plural lower ventilation openings 42 and a lower air outlet 43.

The lower ventilation opening 42 is disposed at plural positions on the upper face of the seating part 6. The lower ventilation openings 42 communicate with the inside of the lower air passage 41 having a hollow shape. Thus, the seat air conditioning unit 40 is capable of drawing air above the seating part 6 into the lower air passage 41 through the cushion part of the seating part 6. Each of the lower ventilation openings 42 is an example of the ventilation opening.

The lower air outlet 43 is formed on the end of the lower air passage 41, and projects from the lower face of the seating part 6. Thus, in the present embodiment, a space above the seating part 6 communicates with a space below the seating part 6 through the cushion part and the lower air passage 41 of the seating part 6.

The lower blower 44 is disposed on the air flow passage of the lower air passage 41 inside the seating part 6 of the seat 5. That is, the lower blower 44 is disposed between the lower ventilation openings 42 and the lower air outlet 43 on the lower air passage 41.

The lower blower 44 is configured to perform an air blowing operation in accordance with a control signal from the air conditioning controller 50 and capable of adjusting the air blowing amount by controlling the operation of a motor (not illustrated). Thus, the lower blower 44 is capable of drawing air inside the cabin C through the lower ventilation openings 42 on the lower air passage 41 and discharging the air into the cabin C through the lower air outlet 43 by performing the air blowing operation. The lower blower 44 functions as the seat air blower.

The upper air passage 45 is disposed inside the backrest part 7 behind a cushion part of the backrest part 7. The upper air passage 45 is configured as a combination of metal pipes in a manner similar to the lower air passage 41. Thus, the upper air passage 45 functions as a skeleton material part in the backrest part 7 of the seat 5. The upper air passage 45 functions as a flow passage of air in the backrest part 7 of the seat air conditioning unit 40 and includes plural upper ventilation openings 46 and an upper air outlet 47.

The upper ventilation opening 46 is disposed at plural positions on the front face of the backrest part 7. The upper ventilation openings 46 communicate with the inside of the upper air passage 45 having a hollow shape. Thus, the seat air conditioning unit 40 is capable of drawing air ahead of the backrest part 7 into the upper air passage 45 through the cushion part of the backrest part 7. Each of the upper ventilation openings 46 is an example of the ventilation opening.

The upper air outlet 47 is formed on the end of the upper air passage 45 and disposed on the back face side of the backrest part 7. Thus, a space ahead of the backrest part 7 communicates with a space behind the backrest part 7 through the cushion part and the upper air passage 45 of the backrest part 7.

The upper blower 48 is disposed on the air flow passage of the upper air passage 45 inside the backrest part 7 of the seat 5. That is, the upper blower 48 is disposed between the upper ventilation openings 46 and the upper air outlet 47 on the upper air passage 45.

The upper blower 48 is configured to perform an air blowing operation in accordance with a control signal from the air conditioning controller 50 and capable of adjusting the air blowing amount by controlling the operation of a motor (not illustrated). The upper blower 48 is capable of drawing air inside the cabin C through the upper ventilation openings 46 on the upper air passage 45 and discharging the air into the cabin C through the upper air outlet 47 by performing the air blowing operation. The upper blower 48 functions as the seat air blower.

The seat air conditioning unit 40 receives power supplied from an onboard battery. A power line from the onboard battery includes coil wiring having an allowance so as to allow the seat 5 to slide.

The seat air conditioning unit 40 configured in this manner is capable of taking air inside the cabin C into the seating part 6 and the backrest part 7 of the seat 5 by operating in accordance with control by the air conditioning controller 50 to improve the comfort of the occupant seated on the seat 5.

Next, the configuration of a control system of the vehicle air conditioner 1 according to the present embodiment will be described with reference to FIG. 2. The air conditioning controller 50 is a controller that controls the operation of each control target device included in the vehicle air conditioner 1 and an example of the controller. The air conditioning controller 50 includes a known microcomputer including a CPU, a ROM and a RAM, and a peripheral circuit thereof.

The air conditioning controller 50 according to the present embodiment is configured to control the operations of all of control target devices included in the cabin air conditioning unit 10 and control target devices included in the seat air conditioning unit 40. However, the air conditioning controller 50 may include a controller for the cabin air conditioning unit 10 and a controller for the seat air conditioning unit 40, separately.

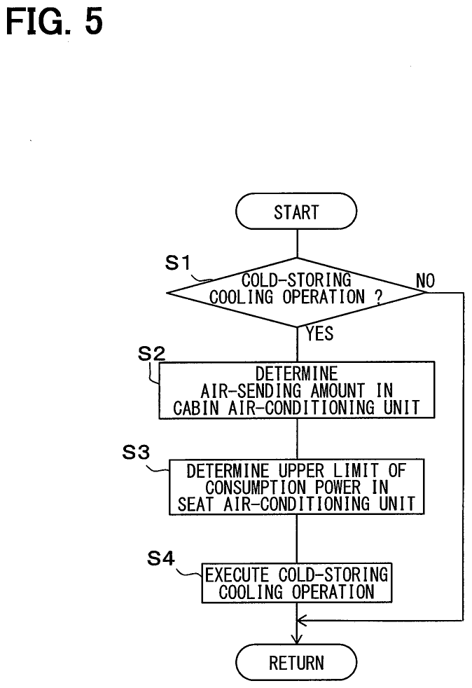

The air conditioning controller 50 according to the present embodiment stores a control program for performing a cabin air conditioning operation by the vehicle air conditioner 1 in the ROM thereof and performs various operations and processing in accordance with the control program. A control program for performing a cold-storing cooling operation illustrated in FIG. 5 is also stored in the ROM of the air conditioning controller 50. The cold-storing cooling operation and the details of the control will be described below with reference to the drawings.

An air conditioning sensor group is connected to an input side of the air conditioning controller 50. Thus, the air conditioning controller 50 is capable of performing various detection operations on the basis of sensor detection signals output from the air conditioning sensor group. The air conditioning sensor group includes an outside air sensor 51, an inside air sensor 52, a solar radiation sensor 53, an evaporator temperature sensor 54, and a water temperature sensor 55.

The outside air sensor 51 detects an outside air temperature Tam which is the temperature of outside air outside the vehicle. The inside air sensor 52 detects an inside air temperature Tr which is the temperature inside the cabin C. The solar radiation sensor 53 detects a solar radiation amount Ts inside the cabin C. The evaporator temperature sensor 54 detects a temperature of ventilation air passing through the evaporator 21 (that is, a blowout temperature). The evaporator temperature sensor 54 is attached to the fin 21d included in the evaporator 21. The water temperature sensor 55 detects a temperature Tw of the engine coolant flowing into the heater core 26.

A control panel 56 is connected to the input side of the air conditioning controller 50. The control panel 56 is disposed near the instrument panel on the front part of the cabin. The control panel 56 includes various operation switches relating to the cabin air conditioning unit 10 and the seat air conditioning unit 40 of the vehicle air conditioner 1. Thus, the air conditioning controller 50 is capable of detecting operations with respect to the control panel 56 on the basis of operation signals output from the various switches of the control panel 56.

The various switches included in the control panel 56 include a blowoff mode switch, an inside and outside air selector switch, an air conditioning switch, an air blowing switch, an automatic switch, a temperature setting switch, and a seat air conditioning switch.

The blowoff mode switch is operated to manually set a blowoff mode which is switched by the blowoff mode doors (that is, the defroster door 33 to the foot door 35) of the cabin air conditioning unit 10 described above. The inside and outside air selector switch is operated to manually set an inside and outside air suction mode in the inside and outside air switching box 14.

The air conditioning switch is operated to switch the start and stop of cooling and heating or dehumidification inside the cabin C by the cabin air conditioning unit 10. The air blowing switch is operated to manually set the amount of air blown from the indoor air blower 17. The automatic switch is operated to set or cancel automatic control of air conditioning by the cabin air conditioning unit 10.

The seat air conditioning switch is operated to switch the start and stop of the seat air conditioning operation by the seat air conditioning unit 40. When an instruction to start the seat air conditioning operation is given by the operation of the seat air conditioning switch, the air conditioning controller 50 starts the lower blower 44 and the upper blower 48.

Various control devices in the vehicle air conditioner 1 are connected to an output side of the air conditioning controller 50. The control device relating to the cabin air conditioning unit 10 includes the electromagnetic clutch 22a and the electromagnetic displacement control valve 22b of the compressor 22, the servomotor 16, the servomotor 29, and the servomotor 36 which constitute the electric driver, the motor 17b of the indoor air blower 17, and the motor 23b of the cooling fan 23a. The control device relating to the seat air conditioning unit 40 includes the lower blower 44 and the upper blower 48. The operations of the various control devices in the vehicle air conditioner 1 are controlled by output signals of the air conditioning controller 50.

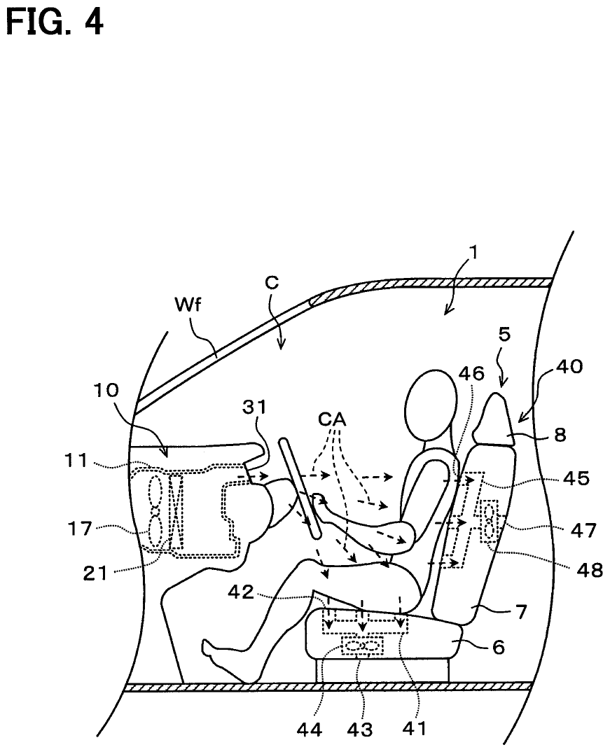

Next, the outline of the cold-storing cooling operation performed in the vehicle air conditioner 1 according to the present embodiment will be described with reference to FIG. 4. The vehicle air conditioner 1 according to the present embodiment is capable of executing the normal cooling operation and the cold-storing cooling operation as cooling operations for cooling the cabin C.

The normal cooling operation in the present embodiment indicates an operation mode in which the refrigerant inside the refrigeration cycle 20 is circulated by the operation of the compressor 22, and air from the indoor air blower 17 is cooled by evaporation of the refrigerant in the evaporator 21 and blown into the cabin C in the cabin air conditioning unit 10 of the vehicle air conditioner 1.

As described above, the cold-storing material container 21e is thermally coupled between the tubes 21c in the evaporator 21. Thus, cold heat generated by the evaporation of the refrigerant in the evaporator 21 is stored in the cold-storing material inside the cold-storing material containers 21e along with the normal cooling operation.

The normal cooling operation in the present embodiment is based on the premise that the refrigeration cycle 20 of the cabin air conditioning unit 10 is in operation (that is, the compressor 22 and the like are in operation), and the seat air conditioning unit 40 is not in operation.

The cold-storing cooling operation in the present embodiment indicates an operation mode in which air from the indoor air blower 17 is cooled using cold heat stored in the cold-storing material inside the cold-storing material containers 21e in the evaporator 21 by the normal cooling operation and blown into the cabin C, and, at the same time, the seat air conditioning is performed by the seat air conditioning unit 40.

The operation mode of the vehicle air conditioner 1 during the cold-storing cooling operation according to the present embodiment will be described in detail. As described above, in the cold-storing cooling operation, cold stored in the cold-storing material inside each of the cold-storing material containers 21e is used. Thus, in the cabin air conditioning unit 10, it is not necessary that the refrigerant circulates inside the refrigeration cycle 20. That is, for example, the cold-storing cooling operation can be performed even when the compressor 22 in the refrigeration cycle 20 is stopped by a stop of the vehicle engine E.

Specifically, in the cold-storing cooling operation, the operation of the indoor air blower 17 is controlled in the cabin air conditioning unit 10. The indoor air blower 17 blows air to the evaporator 21 in accordance with an air blowing amount determined by the control process illustrated in FIG. 5. The air blown in this manner is cooled by cold heat stored in the cold-storing material inside each of the cold-storing material containers 21e when passing through the evaporator 21 and blown as the cold air CA into the cabin C through the face blowoff port 31 and the like.

At this time, the seat air conditioning by the seat air conditioning unit 40 is performed in an operation mode determined by the control process illustrated in FIG. 5 along with the cold-storing cooling operation. Thus, when the cold air CA cooled by cold of the cold-storing material is blown into the cabin C, the cold air CA flows toward the seat 5 along with the operations of the lower blower 44 and the upper blower 48 of the seat air conditioning unit 40.

In the seat air conditioning unit 40, the lower ventilation openings 42 are disposed on the upper side of the seating part 6 of the seat 5, and the upper ventilation openings 46 are disposed on the front side of the backrest part 7 of the seat 5. As illustrated in FIGS. 1 and 4, the upper face of the seating part 6 and the front face of the backrest part 7 are parts capable of making contact with the body of the occupant seated on the seat 5.

Thus, in the cold-storing cooling operation, the cold air CA cooled by cold of the cold-storing material flows near the body surface of the occupant seated on the seat 5, and is drawn into the seating part 6 and the backrest part 7 by the operations of the lower blower 44 and the upper blower 48 of the seat air conditioning unit 40. Accordingly, the cold-storing cooling operation makes it possible to feed the cold air CA cooled by cold heat of the cold-storing material concentratedly to the occupant seated on the seat 5. Thus, it is possible to efficiently improve the comfort of the occupant.

FIG. 4 illustrates only the cold air CA blown into the cabin C through the face blowoff port 31 and omits the flow of cold air CA blown through the foot blowoff port 32 and the defroster door 33. At this time, when cold air CA is blown into the cabin C through the foot blowoff port 32 and the defroster door 33, the cold air CA flows toward the lower ventilation openings 42 and the upper ventilation openings 46 of the seat air conditioning unit 40 in a manner similar to the cold air CA in FIG. 4.

Next, the details of the control process relating to the cold-storing cooling operation of the vehicle air conditioner 1 according to the present embodiment will be described with reference to the flowchart of FIG. 5. The control program is executed by the air conditioning controller 50 along with a start of the normal cooling operation in the vehicle air conditioner 1.

The start of the normal cooling operation in the vehicle air conditioner 1 is determined, for example, on the basis of an operation signal of the air conditioning switch or the automatic switch of the control penal 56. Control steps in the flowchart illustrated in FIG. 5 constitute various function implementation sections included in the air conditioning controller 50.

As illustrated in FIG. 5, in step S1, it is determined whether to switch the operation mode of the vehicle air conditioner 1 to the cold-storing cooling operation. Specifically, it is determined whether to switch the operation mode to the cold-storing cooling operation according to whether the operation of the compressor 22 in the cabin air conditioning unit 10 has been stopped during the normal cooling operation.

When it is determined that the operation of the compressor 22 has been stopped, the process is shifted to step S2 in order to start the cold-storing cooling operation. When it is determined that the operation of the compressor 22 has been continued, the control process is finished without switching the operation mode to the cold-storing cooling operation in order to continue the normal cooling operation.

In the cabin air conditioning unit 10, the operation of the compressor 22 is linked with the operation of the vehicle engine E. Thus, when the vehicle engine E comes to a stop, for example, for no idling, the operation of the compressor 22 along with the normal cooling operation also comes to a stop. In step S1 in this case, it is determined that the operation mode is switched to the cold-storing cooling operation.

In step S2 to which the process is shifted to execute the cold-storing cooling operation, the air blowing amount of the indoor air blower 17 during the cold-storing cooling operation is determined. The air blowing amount of the indoor air blower 17 in this case is determined to be lower than the air blowing amount of the indoor air blower 17 in a case where only the cabin air conditioning unit 10 is operated (e.g., during the normal cooling operation).

Specifically, in step S2, the air blowing amount of the indoor air blower 17 during the cold-storing cooling operation is determined on the basis of a control map stored in the ROM of the air conditioning controller 50 and the air blowing amount of the indoor air blower 17 during the normal cooling operation.

The control map which is referred to in step S2 is generated on the conditions that the air blowing amount of the indoor air blower 17 is smaller during the cold-storing cooling operation than during the normal cooling operation and that an air velocity at the seating position of the occupant on the seat 5 is the same between the normal cooling operation and the cold-storing cooling operation.

During the normal cooling operation, only the cabin air conditioning unit 10 is operated to perform the cooling operation. Thus, the air velocity at the seating position of the occupant on the seat 5 corresponds to the air blowing amount of the indoor air blower 17. On the other hand, in the cold-storing cooling operation, both the cabin air conditioning unit 10 and the seat air conditioning unit 40 are used in combination. As illustrated in FIGS. 1 and 4, the seating position of the occupant in the present embodiment corresponds to the upper side of the seating part 6 and the front side of the backrest part 7 in the seat 5.

Thus, the air velocity at the seating position during the cold-storing cooling operation is affected by not only air blown to the seating position by the indoor air blower 17, but also air drawn by the lower blower 44 and the upper blower 48 from the seating position.

Thus, the control map which is referred to in step S2 is generated so that the above two conditions are satisfied by associating the air blowing amount of the indoor air blower 17 during the cold-storing cooling operation and the air blowing amount of the lower blower 44 and the upper blower 48 during the cold-storing cooling operation with respect to the air blowing amount of the indoor air blower 17 during the normal cooling operation.

In step S2, the air blowing amount of the indoor air blower 17 during the cold-storing cooling operation is specified by referring to the air blowing amount of the indoor air blower 17 during the normal cooling operation and the control map. The air blowing amount of the indoor air blower 17 during the cold-storing cooling operation determined in this manner is capable of maintaining the air velocity at the seating position of the occupant to be the same as the air velocity during the normal cooling operation and is smaller than the air blowing amount of the indoor air blower 17 during the normal cooling operation.

In the following step S3, an upper limit of power consumption consumed by the seat air conditioning unit 40 during the cold-storing cooling operation is determined. Specifically, the upper limit of power consumption is determined to indicate the difference between power consumption of the cabin air conditioning unit 10 during the normal cooling operation and power consumption of the cabin air conditioning unit 10 during the cold-storing cooling operation.

The operation mode of the cabin air conditioning unit 10 differs between the normal cooling operation and the cold-storing cooling operation mainly in the difference in the air blowing amount of the indoor air blower 17 determined in step S2. Thus, the upper limit of power consumption corresponds to a reduction amount of power consumption consumed by the cabin air conditioning unit 10 along with a reduction in the air blowing amount of the indoor air blower 17 between the normal cooling operation and the cold-storing cooling operation.

When the process shifts to step S4, the cold-storing cooling operation is executed in accordance with the operation conditions (that is, the air blowing amount of the indoor air blower 17, the upper limit of power consumption in the seat air conditioning unit 40, and the like) determined in steps S2 and S3.

That is, the operations of the indoor air blower 17 of the cabin air conditioning unit 10 and the lower blower 44 and the upper blower 48 of the seat air conditioning unit 40 are controlled so as to achieve the air blowing amount determined in step S2. Accordingly, the air velocity at the seating position of the occupant is maintained. Thus, it is possible to maintain the comfort of the occupant similarly to the comfort during the normal cooling operation.

During the cold-storing cooling operation, the operation of the seat air conditioning unit 40 is controlled so that the power consumption of the seat air conditioning unit 40 becomes equal to or less than the upper limit of power consumption determined in step S3. Accordingly, it is possible to perform the cold-storing cooling operation using both the cabin air conditioning unit 10 and the seat air conditioning unit 40 with a power consumption equal to or less than that during the normal cooling operation.

The cold-storing cooling operation according to the present embodiment is finished by the start of the compressor 22 linked with the start of the engine E and switched to the normal cooling operation. Thus, when the blowout temperature of the evaporator 21 exceeds the predetermined reference blowout temperature KT (e.g., 15° C.), the compressor 22 starts operating by a restart of the vehicle engine E. Thus, the cold-storing cooling operation is finished and switched to the normal cooling operation.

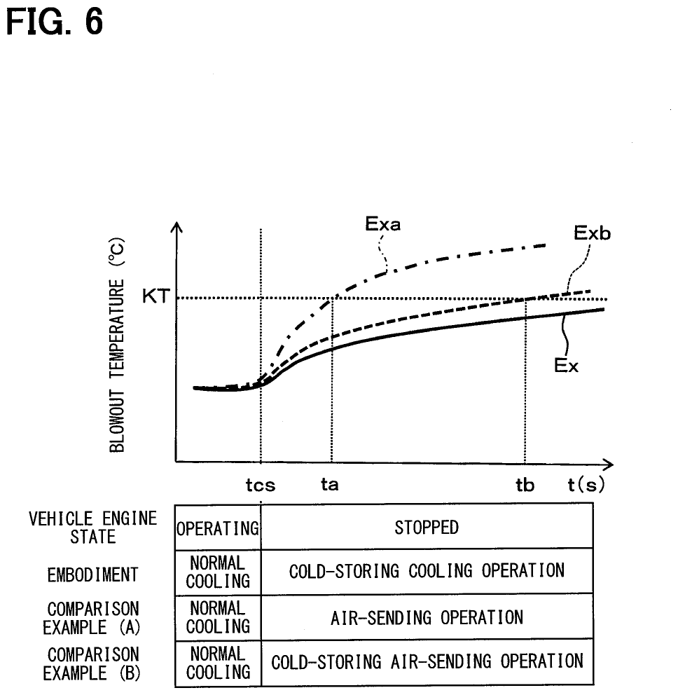

Next, the cold-storing cooling operation in the vehicle air conditioner 1 according to the present embodiment is compared with another air conditioning operation in which a compressor is stopped. The air blowout temperature of the evaporator 21 in the case of the cold-storing cooling operation according to the present embodiment is denoted by “Ex” in the graph of FIG. 6.

A vehicle air conditioner according to a comparison example (A) includes a cabin air conditioning unit 10 in which an evaporator of a refrigeration cycle 20 has no thermal storage function. In the graph of FIG. 6, an air blowout temperature of the evaporator in the comparison example (A) is denoted by “Exa”.

A vehicle air conditioner according to a comparison example (B) includes a cabin air conditioning unit 10 in which an evaporator 21 of a refrigeration cycle 20 has a thermal storage function, and does not include the seat air conditioning unit 40. In the graph of FIG. 6, an air blowout temperature of the evaporator in the comparison example (B) is denoted by “Exb”.

The vehicle air conditioner 1 according to the present embodiment, the vehicle air conditioner according to the comparison example (A), and the vehicle air conditioner according to the comparison example (B) are compared on the premise that the vehicle engine E of the vehicle is in operation, and the normal cooling operation for cooling the cabin is performed by the refrigeration cycle 20 as an initial state. The operations of the vehicle engine E and the compressor come to a stop at the point when a predetermined time tcs has elapsed from the initial state.

An air conditioning operation after the stop of the operation of the compressor will be described. In the case of the comparison example (A), the operation of the refrigeration cycle 20 in the cabin air conditioning unit 10 also comes to a stop along with the stop of the operation of the compressor. Thus, the cabin air conditioning unit 10 performs an air-sending operation. In the air-sending operation, only air blowing by the indoor air blower 17 in the cabin air conditioning unit 10 into the cabin C is performed. Thus, as illustrated in the graph of FIG. 6, after the compressor stops operating, the air blowout temperature in the evaporator rises with the elapse of time and exceeds the reference blowout temperature KT at the point when a time ta has elapsed.

In the case of the comparison example (B), a cold-storing air-sending operation by the cabin air conditioning unit 10 is performed along with the stop of the operation of the compressor 22. Specifically, in the cold-storing air-sending operation, air is cooled using cold heat stored in the evaporator 21 and supplied into the cabin C by operating the indoor air blower 17.

In this case, since the air is cooled by cold heat stored in the evaporator 21, the blowout temperature in the comparison example (B) rises more slowly than the comparison example (A). That is, even at the time ta, the cold air CA can be supplied into the cabin C. Then, at a time tb after the elapse of more time, the blowout temperature in the comparison example (B) exceeds the reference blowout temperature KT.

As described above, the vehicle air conditioner 1 according to the present embodiment performs the cold-storing cooling operation along with the stop of the operation of the compressor 22. In the cold-storing cooling operation, air cooled by cold stored in the cold-storing material inside the cold-storing material containers 21e of the evaporator 21 is supplied into the cabin C by operating the cabin air conditioning unit 10 and the seat air conditioning unit 40.

As illustrated in the graph of FIG. 6, according to the cold-storing cooling operation in the vehicle air conditioner 1, the blowout temperature in the evaporator 21 is lower than the reference blowout temperature KT even at the point when any of the time ta and the time tb has elapsed from the stop of the operation of the compressor 22 at the predetermined time tcs.

As described above, the air blowing amount of the indoor air blower 17 during the cold-storing cooling operation is determined to be smaller than the air blowing amount in a case where only the cabin air conditioning unit 10 is operated (e.g., during the normal cooling operation or the cold-storing air-sending operation of the comparison example (B)). The reduction in the air blowing amount in the indoor air blower 17 makes it possible to reduce the amount of air passing through the evaporator 21. Thus, it is possible to maintain the blowout temperature during the cold-storing cooling operation lower than the reference blowout temperature KT for a long time exceeding the time ta and the time tb.

That is, the vehicle air conditioner 1 according to the present embodiment makes it possible to more effectively utilize cold heat inside the cold-storing material containers 21e of the evaporator 21 and perform cooling the cabin with higher efficiency than the comparison example (A) and the comparison example (B) even when the operation of the compressor is stopped during the cold-storing cooling operation.

As can be seen from the graph of FIG. 6, the vehicle air conditioner 1 according to the present embodiment makes it possible to extend the time period before the blowout temperature exceeds the reference blowout temperature KT as compared to the comparison example (A) and the comparison example (B). That is, the vehicle air conditioner 1 makes it possible to extend a period to the restart of the vehicle engine E (that is, the no-idling period), and maintain the comfort inside the vehicle C equal to or higher than a predetermined comfort level and, at the same time, increase a fuel saving effect by the stop of the operation of the vehicle engine E.

The fuel saving effect will be described with reference to a fuel consumption rate estimated for each of the vehicle air conditioner 1 according to the present embodiment, the comparison example (A), and the comparison example (B). When the fuel consumption rate of the comparison example (A) is 100 (%), the fuel consumption rate of the comparison example (B) which performs the cold-storing air-sending operation using the evaporator having the cold storage function is 86 (%), and the fuel consumption rate of the vehicle air conditioner 1 which performs the cold-storing cooling operation using both the cabin air conditioning unit 10 and the seat air conditioning unit 40 in combination is 83 (%). The estimation result shows that the vehicle air conditioner 1 increases the fuel saving effect by the stop of the operation of the vehicle engine E.

As described above, as illustrated in FIG. 1, the vehicle air conditioner 1 according to the present embodiment includes the cabin air conditioning unit 10 disposed on the front side of the cabin C, the seat air conditioning unit 40 disposed in the seat 5 inside the cabin C, and the air conditioning controller 50 which controls the operations of the cabin air conditioning unit 10 and the seat air conditioning unit 40. The cabin air conditioning unit 10 has the refrigeration cycle 20 and the indoor air blower 17. The refrigeration cycle 20 includes the evaporator 21 having the cold storage function. The cabin air conditioning unit 10 is capable of executing one mode that cools air by the operation of the refrigeration cycle 20 and blows the cooled air into the cabin C and another mode that cools air by cold stored in the cold-storing material inside the cold-storing material containers 21e in the evaporator 21 and blows the cooled air into the cabin C.

The seat air conditioning unit 40 in the vehicle air conditioner 1 is capable of drawing air inside the cabin C through the lower ventilation openings 42 and the upper ventilation openings 46 which are disposed on the seat 5 by operating the lower blower 44 and the upper blower 48. Accordingly, the vehicle air conditioner 1 is capable of forming a flow of air to the seat 5 inside the cabin C. Thus, it is possible to increase the comfort of the occupant seated on the seat 5.

The vehicle air conditioner 1 is capable of performing the cold-storing cooling operation without operating the compressor 22 by using both the cabin air conditioning unit 10 and the seat air conditioning unit 40 in combination.

As illustrated in FIG. 4, in the cold-storing cooling operation, air sent from the indoor air blower 17 is cooled by cold heat stored by the evaporator 21 and blown into the cabin C, flows toward the seat 5 by the operations of the lower blower 44 and the upper blower 48 of the seat air conditioning unit 40, and is drawn through the lower ventilation openings 42 and the upper ventilation openings 46. According to the vehicle air conditioner 1, such a flow of the cold air CA can be formed. Thus, it is possible to efficiently improve the comfort of the occupant inside the cabin C.

In the cold-storing cooling operation, the vehicle air conditioner 1 lowers the air conditioning performance of the cabin air conditioning unit 10 by decreasing the air blowing amount of the indoor air blower 17 in the cabin air conditioning unit 10 to be lower than that during the normal cooling operation by executing the control program illustrated in FIG. 5. Accordingly, the vehicle air conditioner 1 is capable of keeping a balance between the comfort of the occupant inside the cabin C and the energy consumption as the vehicle air conditioner 1 as compared to the case where the cabin air conditioning unit 10 and the seat air conditioning unit 40 are simply operated at the same time.

According to the vehicle air conditioner 1, cold heat stored in the cold-storing material inside the cold-storing material containers 21e in the evaporator 21 can be used for a longer period of time. Thus, it is possible to contribute to energy saving as the vehicle air conditioner 1.

The cabin air conditioning unit 10 in the vehicle air conditioner 1 includes, as the cooler, the refrigeration cycle 20 having the evaporator 21, the compressor 22, the condenser 23, and the expansion valve 25. As illustrated in FIG. 3, the evaporator 21 includes the cold-storing material containers 21e which stores the cold-storing material inside thereof.

Thus, according to the vehicle air conditioner 1, it is possible to perform not only the cooling operation inside the cabin C (that is, the normal cooling operation and the cold-storing cooling operation), but also a heating operation and a dehumidification heating operation inside the cabin C by controlling the operation of the cabin air conditioning unit 10 and improve the comfort of the occupant inside the cabin C. Further, since the cold-storing material containers 21e which store the cold-storing material therein are included as components of the evaporator 21, it is possible to reliably store cold during the normal cooling operation and reliably cool air from the indoor air blower 17 during the cold-storing cooling operation.

In the vehicle air conditioner 1, the compressor 22 of the cabin air conditioning unit 10 is driven by the operation of the vehicle engine E. Thus, the operation of the refrigeration cycle 20 also comes to a stop along with the stop of the operation of the vehicle engine E. In the cold-storing cooling operation, when the restart of the refrigeration cycle 20 is required due to an environmental change of the cabin C, the restart of the vehicle engine E is required.

According to the vehicle air conditioner 1, it is possible to use cold stored in the cold-storing material inside the cold-storing material containers 21e in the evaporator 21 for a longer period of time. Thus, it is possible to extend the period until the restart of the vehicle engine E. That is, the vehicle air conditioner 1 makes it possible to extend the no-idling period in the vehicle equipped with the vehicle air conditioner 1 and improve the fuel saving effect of the vehicle.

As illustrated in FIGS. 1 and 4, the seat air conditioning unit 40 in the vehicle air conditioner 1 includes the lower ventilation openings 42 on the upper side of the seating part 6 of the seat 5 and the upper ventilation openings 46 on the front side of the backrest part 7 of the seat 5. That is, the lower ventilation openings 42 and the upper ventilation openings 46 are disposed on the surface capable of making contact with the body of the occupant seated on the seat 5. In the cold-storing cooling operation, the cold air CA blown from the cabin air conditioning unit 10 is drawn through the lower ventilation openings 42 and the upper ventilation openings 46 inside the cabin C by the operation of the seat air conditioning unit 40.

Thus, when the lower ventilation openings 42 and the upper ventilation openings 46 are disposed in this manner, it is possible to guide the cold air CA during the cold-storing cooling operation to the lower ventilation openings 42 and the upper ventilation openings 46 through the vicinity of the occupant seated on the seat 5 and efficiently improve the comfort of the occupant seated on the seat 5.

In step S2, the air blowing amount of the indoor air blower 17 during the cold-storing cooling operation is determined to be lower than the air blowing amount of the indoor air blower 17 during the normal cooling operation. Accordingly, the vehicle air conditioner 1 makes it possible to reduce the amount of air passing through the evaporator 21 having the thermal storage function and use cold stored in the evaporator 21 for a longer period of time during the cold-storing cooling operation.

The air blowing amount of the indoor air blower 17 during the cold-storing cooling operation is determined to obtain air velocity equal to that during the normal cooling operation at the seating position of the occupant. Thus, the vehicle air conditioner 1 makes it possible to maintain the comfort substantially equal to the comfort in the case of the normal cooling operation, also during the cold-storing cooling operation.

In step S3, the upper limit of power consumption by the seat air conditioning unit 40 during the cold-storing cooling operation is determined to be the difference between the power consumption of the cabin air conditioning unit 10 during the normal cooling operation and the power consumption of the cabin air conditioning unit 10 during the cold-storing cooling operation. When the cold storage operation is executed in step S4, the operation of the seat air conditioning unit 40 is controlled so that the power consumption of the seat air conditioning unit 40 becomes equal to or less than the upper limit of power consumption determined in step S3.

Accordingly, the vehicle air conditioner 1 makes it possible to perform the cold-storing cooling operation using both the cabin air conditioning unit 10 and the seat air conditioning unit 40 in combination with a power consumption equal to or less than that during the normal cooling operation of the vehicle air conditioner 1 and contribute to energy saving on power.

### Other Embodiment

While the embodiment is described, the present disclosure is not restricted to the embodiment mentioned, and can be implemented with various modification in the range not deviating from the scope of the present disclosure. For example, the embodiments may be suitably combined. Further, the embodiment may have various modifications as described below.

(1) In the above embodiment, the vehicle air conditioner 1 is mounted on the vehicle driven by the vehicle engine E. However, a vehicle to which the vehicle air conditioner is applicable is not limited to this mode. The vehicle air conditioner can be applied to an electric vehicle which is driven by a motor using power of a vehicle battery or may be applied to a hybrid vehicle which is configured to use a vehicle engine E and a motor.

(2) In the above embodiment, the refrigeration cycle 20 is used as a configuration for cooling the cold-storing material containers 21e as the thermal storage unit in the cabin air conditioning unit 10. However, the present disclosure is not limited to this mode. The cooler may be a configuration capable of cooling the thermal storage unit for causing the thermal storage unit to store cold and can employ various configurations. For example, a Peltier element can be used as the cooler.

(3) In the above embodiment, the seat air conditioning unit 40 includes the lower air passage 41, the lower blower 44 and the like in the seating part 6, and includes the upper air passage 45, the upper blower 48 and the like in the backrest part 7. However, the present disclosure is not limited to this configuration. For example, the seat air conditioning unit 40 may include the air passage, the blower and the like in only one of the seating part 6 and the backrest part 7.

(4) In the above embodiment, the lower air outlet 43 of the lower air passage 41 is disposed on the upper side of the seating part 6 of the seat 5, and the upper air outlet 47 of the upper air passage 45 is disposed on the front side of the backrest part 7 of the seat 5, in the seat air conditioning unit 40. However, the present disclosure is not limited to this mode. It is only required that the ventilation opening be disposed on the seat, and a change can be appropriately made according to various conditions such as the configuration of the seat.

(5) In the above embodiment, in step S2, the air blowing amount of the indoor air blower 17 during the cold-storing cooling operation is determined to be lower than the air blowing amount of the indoor air blower 17 during the normal cooling operation using the control map stored in the ROM of the air conditioning controller 50. However, the present disclosure is not limited to this mode. An extent of reduction and a determination method of the air blowing amount of the indoor air blower 17 during the cold-storing cooling operation can employ various modes as long as the air blowing amount of the indoor air blower 17 during the cold-storing cooling operation can be made lower than that during the normal cooling operation.

(6) In the above embodiment, in step S3, the upper limit of power consumption by the seat air conditioning unit 40 during the cold-storing cooling operation is determined to be the difference between the power consumption of the cabin air conditioning unit 10 during the normal cooling operation and the power consumption of the cabin air conditioning unit 10 during the cold-storing cooling operation. However, the present disclosure is not limited to this mode. The method for determining the upper limit of power consumption can employ various methods as long as the cold-storing cooling operation can be achieved with a power consumption equal to or less than that during the normal cooling operation.

What is claimed is:

1. An air conditioner for a vehicle comprising:
a cabin air conditioner disposed on a front side of a cabin of a vehicle, the cabin air conditioner including an indoor air blower that blows air into the cabin, a cooler that cools air blown by the indoor air blower, and a thermal storage unit that stores a cold heat generated by the cooler;
a seat air conditioner including a ventilation opening formed on a seat disposed inside the cabin and a seat air blower that draws air inside the cabin through the ventilation opening; and
a controller that controls the cabin air conditioner and the seat air conditioner, wherein
the controller controls the cabin air conditioner to cool air by the cold heat stored in the thermal storage unit, and the controller lowers an air conditioning performance of the cabin air conditioner when the seat air conditioner is operated,
when the seat air conditioner is operated, the controller reduces an air blowing amount of the indoor air blower in the cabin air conditioner to be lower than an air blowing amount of the indoor air blower in a case where only the cabin air conditioner is operated, and
the controller controls a power consumption of the seat air conditioner to be lower than or equal to a power reduction amount of the cabin air conditioner in response to a reduction in the air blowing amount of the indoor air blower.

2. The air conditioner according to claim 1, wherein
the cooler comprises a refrigeration cycle including:
a compressor that compresses and discharges a refrigerant;
a condenser that condenses the refrigerant discharged from the compressor to release heat from the refrigerant;
a decompressor that decompresses the refrigerant after the heat release by the condenser; and
an evaporator in which heat is exchanged between the refrigerant decompressed by the decompressor and the air to evaporate the refrigerant, wherein
the thermal storage unit is capable of performing heat exchange with the refrigerant in the evaporator.

3. The air conditioner according to claim 2, wherein the compressor is driven by an operation of an engine that is a power source of the vehicle.

4. The air conditioner according to claim 1, wherein the ventilation opening is disposed on a surface of the seat to be in contact with a body of an occupant seated on the seat.
